(19) United States
(12) Patent Application Publication
(10) Pub. No.: US 2013/0241867 A1
(43) Pub. Date: Sep. 19, 2013

(54) CAPACITIVE TOUCH PANEL AND APPARATUS FOR MANUFACTURING SAME

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng, New Taipei (TW)

(21) Appl. No.: 13/585,851

(22) Filed: Aug. 15, 2012

(30) Foreign Application Priority Data
Mar. 14, 2012 (TW) 101108648

(51) Int. Cl. G06F 3/044; B32B 38/16; B32B 37/02

(52) U.S. Cl. 345/174; 156/390; 156/380.9

(57) ABSTRACT

A capacitive touch panel includes a flexible substrate, a first sensing layer, a first protective film, a second sensing layer, and a second protective film. The substrate includes a first surface and a second surface opposite to the first surface. The first sensing layer and the first protective film are formed on the first surface. The second sensing layer and the second protective film are formed on the second surface. The first sensing layer includes a first cladding portion defining a first receiving groove and a first conductive portion received in the first receiving groove. The second sensing layer includes a second cladding portion defining a second receiving groove and a second conductive portion received in the second receiving groove.

### BACKGROUND

1. Technical Field

The present disclosure relates to a capacitive touch panel and an apparatus for manufacturing the capacitive touch panel.

2. Description of Related Art

The capacitive touch panels are made from glasses, thus are fragile and easily damaged. This characteristic also leads to difficulties in manufacturing.

Therefore, it is desirable to provide a capacitive touch panel and an apparatus for manufacturing same that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, explode view of a capacitive touch panel, according to a first exemplary embodiment.

FIG. 2 is a schematic, assembled view of the capacitive touch panel of FIG. 1.

FIG. 3 is a cross-sectional view of the capacitive touch panel of FIG. 2, taken along a line III-III.

FIG. 4 is a schematic view of an apparatus for manufacturing the capacitive touch panel, according to a second exemplary embodiment, wherein the apparatus includes a first pressing roller, a second pressing roller and a third pressing roller.

FIG. 5 is a schematic view of the first pressing roller of FIG. 4.

FIG. 6 is a schematic view of the third pressing roller of FIG. 4.

### DETAILED DESCRIPTION

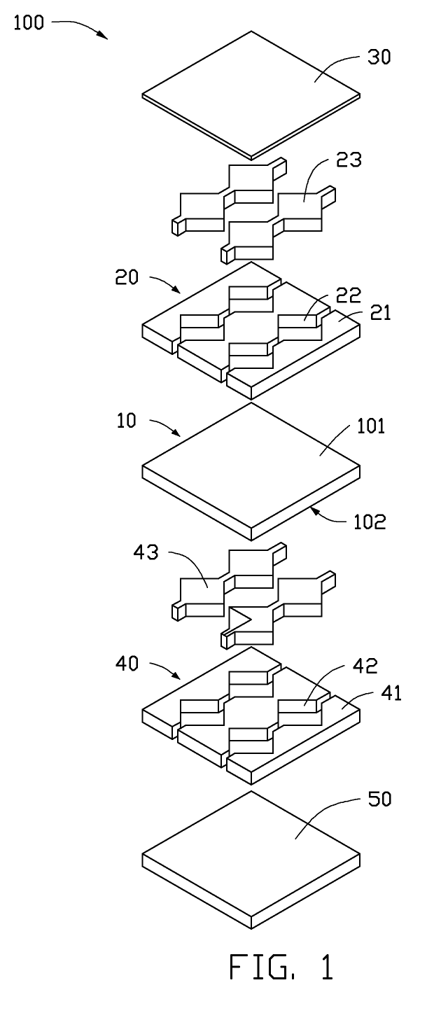

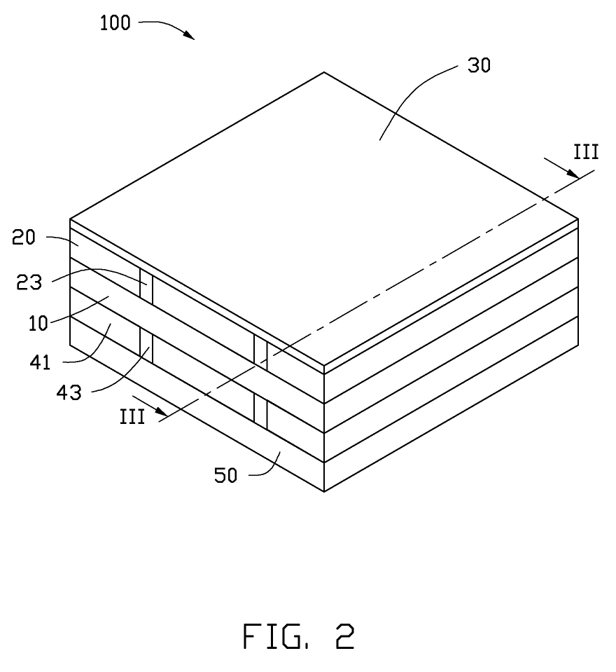

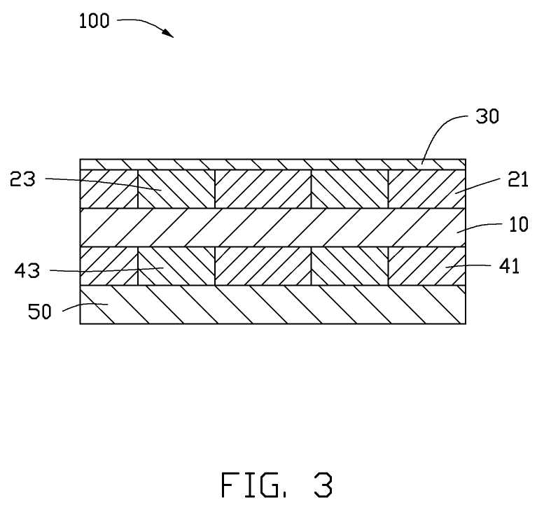

FIGS. 1-3 illustrate a capacitive touch panel 100 in accordance to a first embodiment. The capacitive touch panel 100 includes a flexible substrate 10, a first sensing layer 20, a first protective film 30, a second sensing layer 40, and a second protective film 50.

The substrate 10 includes a first surface 101 and a second surface 102 opposite to the first surface 101. The substrate 10 can be made of polyethylene terephthalate (PET), polyethersulfone (PES) or other flexible transparent material.

The first sensing layer 20 is formed on the first surface 101, and the first protective film 30 is positioned on the first sensing layer 20. The second sensing layer 40 is formed on the second surface 102, and the second protective film 50 is positioned on the second sensing layer 40.

The first sensing layer 20 includes a first cladding portion 21 and a first conductive portion 23. The first cladding portion 21 defines a first receiving groove 22. The first conductive portion 23 is received in the receiving groove 22 and is coupled with the receiving groove 22. In this embodiment, the first cladding portion 21 is made of ultraviolet glue, the first conductive portion 23 is made of conductive macromolecule material, such as Poly(3,4-ethylenedioxythiophene):Poly(styrenesulfonate) (PEDOT:PSS).

The second sensing layer 40 includes a second cladding portion 41 and a second conductive portion 43. The second cladding portion 41 defines a second receiving groove 42. The second conductive portion 43 is received in the second receiving groove 42 and is coupled with the second receiving groove 42. In this embodiment, the material of the first cladding portion 21 is substantially the same as the material of the second cladding portion 41, and the material of the second conductive portion 43 is substantially the same as the material of the first conductive portion 23.

The first protective film 30 and the second protective film 50 are made of insulating material, such as silicon nitride or plastic.

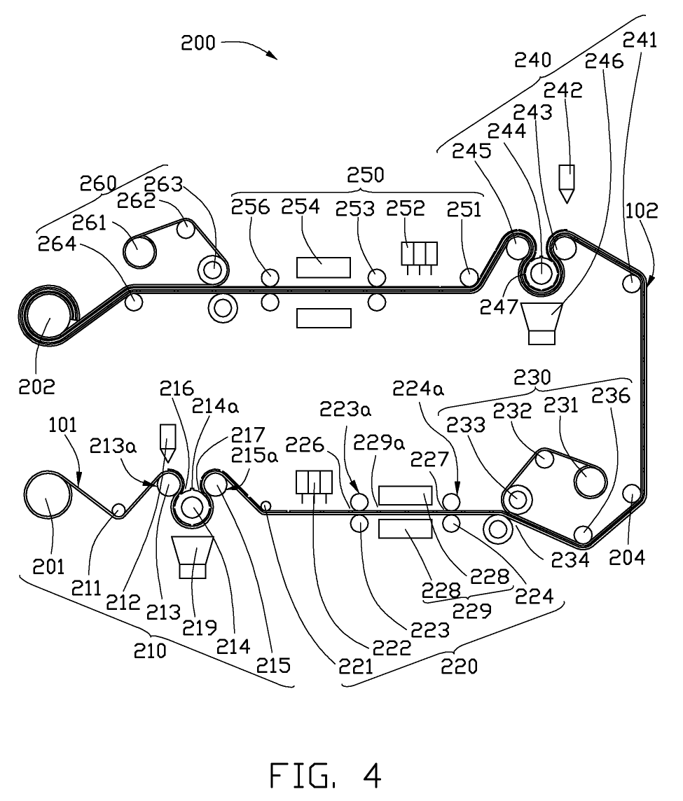

Referring to FIG. 4, an apparatus 200 for making the capacitive touch panel 100 includes a release reel 201 and a film retracting reel 202. The apparatus 200 further includes a first roller pressing device 210, a second roller pressing device 220, a third roller pressing device 230, a fourth roller pressing device 240, a fifth roller pressing device 250, and a sixth roller pressing device 260 in order along a transmission direction of the substrate 10.

One end of the substrate 10 is wound around the releasing reel 201, and the other end of the substrate 10 is fixed to the film retracting reel 202. The first roller pressing device 210 is used for forming the first cladding portion 21 with the first receiving groove 22 on the first surface 101. The second roller pressing device 220 is used for filling a first conductive portion forming solvent in the first receiving groove 22 to form the first conductive portion 23, and thus to obtain the first sensing layer 20 The first conductive portion forming solvent is a solvent for forming the first conductive portion 23.

The third roller pressing device 230 is used for forming the first protective film 30 on the first sensing layer 20. The fourth pressing device 240 is used for forming the second cladding portion 41 with the second receiving groove 42 on the second surface 102. The fifth pressing device 250 is used for filling a second conductive portion forming solvent in the second receiving groove 42 to obtain the second conductive portion 43, and thus to obtain the second sensing layer 40. The sixth roller pressing device 260 is used for forming the second protective film 50 on the second sensing film 40.

In detail, the first roller pressing device 210 includes a first transmission roller 211, a first feeder 212, a first auxiliary roller 213, a first pressing roller 214, a second auxiliary roller 215, and a first drying element 219. The first auxiliary roller 213 and the second auxiliary roller 215 are positioned on two opposite sides of the first pressing roller 214. A first molding channel 216 is formed between the first auxiliary roller 213 and the first pressing roller 214. A second molding channel 217 is formed between the second auxiliary roller 215 and the first pressing roller 214. The first feeder 212 is positioned above the first auxiliary roller 213 and is used for providing the first cladding portion forming solvent to the first surface 101 of the substrate 10. The first auxiliary roller 213 has a smooth rolling surface 213a. The second auxiliary roller 215 has a smooth rolling surface 215a.

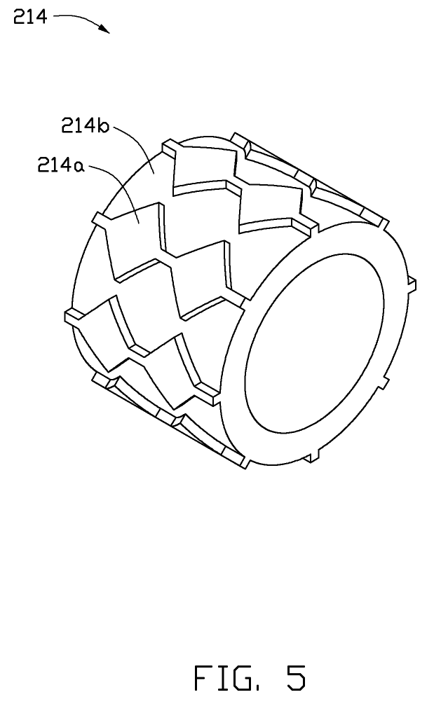

Referring also to FIG. 5, the first pressing roller 214 has a rolling surface 214b defining a first impression pattern 214a mating with the first receiving groove 22. The rotating direction of the first auxiliary roller and the second auxiliary roller are the same as each other and is opposite to the rotating direction of the first pressing roller 214. In this embodiment, the first auxiliary roller 213 and the second auxiliary roller 215 are rotated clockwise, and the first pressing roller 214 is rotated counterclockwise. The first drying element 219 is positioned under the first pressing roller 214. The first cladding portion forming solvent is ultraviolet glue, the first drying element 219 is an ultraviolet source, and the first feeder 212 is a precision slot die.

The substrate 10 extends from a lower edge of the first transmission roller 211 to a higher edge of the first auxiliary roller 213. The first cladding portion forming solvent is then uniformly distributed by the first feeder 212, and passes through the first channel 216 to form the first cladding portion solvent layer. The first drying element 219 solidifies the first cladding portion solvent layer to form the first cladding portion 21. At last, the substrate 10 with the first cladding portion 21 passes through the second channel 217.

The second roller pressing device 220 includes a second transmission roller 221, a second feeder 222, two first front rollers 223, a second drying element 229, and two first rear rollers 224. Each of the two first front rollers 223 has a smooth rolling surface 223a. Each of the two first rear rollers 224 has a smooth rolling surface 224a. A third molding channel 226 is formed between the two first front rollers 223. A fourth molding channel 227 is formed between the two first rear rollers 224. In this embodiment, the second drying element 229 is a heater, and includes two heating sheets 228 parallel to each other. A lengthwise direction of each of the two heating sheets 228 is substantially the same as the transmission direction of the substrate 10. A drying channel 229a is formed between the two heating sheets 228. In this embodiment, the second feeder 222 is a spray printing head.

The substrate 10 with the first cladding portion 20 extends from a lower edge of the second transmission roller 221, and then passes through the third molding channel 226, the drying channel 229a, and the fourth molding channel 227. The second feeder 222 provides a conductive portion forming solvent in the first receiving groove 22. The conductive portion forming solvent is a solvent for forming the conductive portion 23.

Each of the two first front rollers 226 and the two first rear rollers 227 has a smooth rolling surface. The two front rollers 226 are used for pressing the conductive portion forming solvent in the first receiving groove 22. The second drying element 229 is used for solidifying the conductive portion forming solvent. The two first rear rollers 224 are used for pressing the solidified conductive portion forming solvent again to form the first conductive portion 23, and thus to obtain the first sensing layer 20.

The third roller pressing device 230 includes a second releasing reel 231, a third transmission roller 232, two second pressing rollers 233, and a fourth transmission roller 236. A fifth channel 234 is formed between the two second pressing rollers 233. The first sensing layer 20 faces the third transmission roller 232. The first releasing reel 231 is used for paying out a first protective film 30. The first protective film 30 extends through a higher edge of the third transmission roller 232, and then passes through the fifth molding channel 234, and thus the first protective film 30 is pressed on the first sensing layer 20.

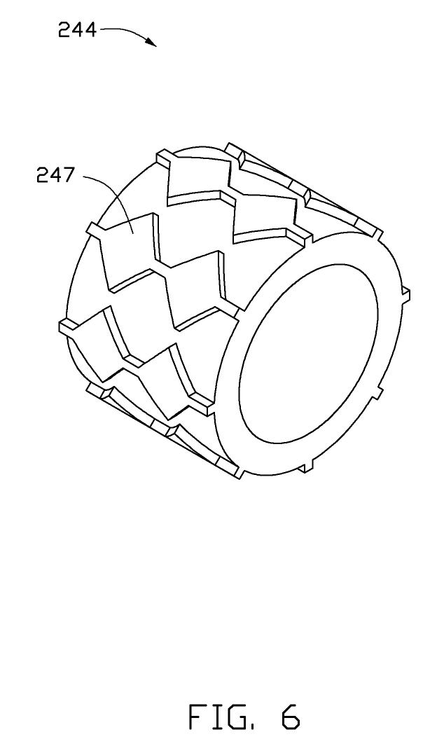

The structure of the fourth pressing device 240 is the same as the structure of the first pressing device 210, and includes a fifth transmission roller 241, a third feeder 242, a third auxiliary roller 243, a third pressing roller 244, and a fourth auxiliary roller 245 along the transmission direction of the substrate 10. The fourth pressing device 240 further includes a third drying element 246 under the third pressing roller 244. Referring also to FIG. 6, the third pressing roller 244 has a rolling surface with a second impression pattern 247 mating with the second receiving groove 42. Each of the third auxiliary roller 243 and the fourth auxiliary roller 245 has a smooth rolling surface. In this embodiment, the third feeder 242 is a precision slot die.

The substrate 10 with the first sensing layer 20 and the first protective film 30 extends from a higher edge of the third auxiliary roller 243, and is coated with a second cladding portion forming solvent on the second surface 102 by the third feeder 242. The second cladding portion forming solvent coated substrate 10 then passes through a molding channel between the third auxiliary roller 243 and the third pressing roller 244 to a lower edge of the third pressing roller 244, and is solidified by the third drying element 246, at last passes through a molding channel between the fourth auxiliary roller 245 and the third pressing roller 244 to form a second cladding portion 41 on the second surface 102. In this embodiment, the second cladding portion forming solvent is ultraviolet glue.

The structure of the fifth pressing device 250 is substantially the same as the structure of the second pressing device 220, and includes a sixth transmission roller 251, a fourth feeder 252, two second front rollers 253, a forth drying element 254, and two second rear rollers 256. The substrate 10 with the first sensing layer 20, the first protective film 30, and the second cladding portion 41 extends through a lower edge of the sixth transmission roller 251, is filled with a second conductive portion forming solvent in the second receiving groove 42 by the fourth feeder 252, then passes through a molding channel between the two second front rollers 253, a drying channel of the fourth drying element 254, and a molding channel between the two second rear rollers 256 to obtain the second sensing layer 40. In this embodiment, the fourth feeder 252 is a spray printed head, and the second conductive portion forming solvent is PEDOT:PSS solvent.

The structure of the sixth pressing device 260 is substantially the same as the structure of the third pressing device 230, and includes a third releasing reel 261, a seventh transmission roller 262, two fourth pressing rollers 263, and an eighth transmission roller 264. The second sensing layer 40 faces the seventh transmission roller 262. The third releasing roller 261 is used for providing the second protective film 50. The second protecting film 50 extends through the higher edge of the seventh transmission roller 262, and a molding channel between the two fourth pressing rollers 263 to press the second protective film 50 on the second sensing layer 40, and thus to obtain the capacitive touch panel 100. The eighth transmission roller 264 transmits the formed capacitive touch panel 100 to the film retracting reel 202. The film retracting reel 202 takes up the formed capacitive touch panel 100. Then, the formed capacitive touch panel 100 can be cut to a predetermined size as required.

In this embodiment, the apparatus 200 further includes a supporting roller 204. The fourth transmission roller 236 is used for transmitting the substrate 10 with the first protective film 30 to the supporting roller 204. The supporting roller 204 is used for transmitting the substrate 10 with the first protective film 30 to the fourth pressing device 240, and making the second surface 102 facing the third pressing roller 244.

In other embodiments, the first to eight transmission rollers, the two first rear rollers and the two second rear rollers can be omitted.

The above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A capacitive touch panel, comprising:
a flexible substrate having a first surface and a second surface opposite to the first surface;
a first sensing layer positioned on the first surface and comprising:
a first cladding portion defining a first receiving groove; and
a first conductive portion received in the first receiving groove;
a first protective film on the first sensing layer;
a second sensing layer positioned on the second surface and comprising:
a second cladding portion defining a second receiving groove; and
a second conductive portion received in the second receiving groove; and
a second protective film on the second sensing layer.

2. The capacitive touch panel of claim 1, wherein the substrate is made of polyethylene terephthalate or polyethersulfone.

3. The capacitive touch panel of claim 1, wherein the first cladding portion is made of ultraviolet glue, and the first conductive portion is made of conductive macromolecule material.

4. The capacitive touch panel of claim 3, wherein the first conductive portion is made of Poly(3,4-ethylenedioxythiophene):Poly(styrenesulfonate).

5. The capacitive touch panel of claim 3, wherein the material of the second cladding portion is substantially the same as the material of the first cladding layer, and the material of the second conductive portion is substantially the same as the material of the first conductive portion.

6. An apparatus for manufacturing a capacitive touch panel, comprising:
a first releasing reel configured for releasing one end of a flexible substrate;
a first roller pressing device comprising:
a first feeder configured for providing a first cladding layer forming solvent to a first surface of the substrate;
a first auxiliary roller;
a first pressing roller having a rolling surface with a first impression pattern for forming a first receiving groove, the first pressing roller cooperating with the first auxiliary roller to pressing the first cladding layer forming solvent to form a first cladding portion solvent layer with the first receiving groove on the first surface;
a first drying element configured for solidifying the first cladding solvent layer to obtain a first cladding layer; and
a second auxiliary roller cooperating with the first pressing roller to press the first cladding layer again;
a second roller pressing device comprising:
a second feeder configured for providing a first conductive portion forming solvent;
two front rollers configured for pressing the first conductive portion forming solvent in the first receiving groove; and
a second drying element configured for solidifying the first conductive portion forming solvent to obtain the first conductive portion, thus a first sensing layer comprising the first cladding layer and the first conductive portion being obtained;
a third roller pressing device comprising:
a second releasing reel configured for providing a protective film; and
two second pressing rollers configured for pressing the protective film on the first sensing layer;
a fourth roller pressing device substantially the same as the first roller pressing device, the fourth roller pressing device configured for forming a second cladding layer with a second receiving groove on a second surface of the substrate opposite to the first surface;
a fifth roller pressing device substantially the same as the second roller pressing device, the fifth roller pressing device configured for filling the second conductive portion in the second receiving groove, thus a second sensing layer comprising the second cladding layer and the second conductive portion being obtained;
a sixth roller pressing device substantially the same as the third roller pressing device, the sixth roller pressing device configured for pressing a second productive film on the second sensing layer to obtain an OPCB; and
a film retracting reel configured for taking up the OPCB.

7. The apparatus of claim 6, wherein each of the first auxiliary roller, the second auxiliary roller, and the two front rollers has a smooth rolling surface.

8. The apparatus of claim 6, wherein the second roller pressing device further comprises two rear rollers configured for pressing the solidified first conductive portion again to make sure the first conductive portion is filled in the first receiving groove, each of the two rear rollers has a smooth rolling surface.

9. The apparatus of claim 6, wherein the first drying element is an ultraviolet source.

10. The apparatus of claim 6, wherein the second drying element is a heater, the heater comprises two parallel heating sheets, a length direction of each of the heating sheets is substantially the same as a transmission direction of the substrate, the substrate with the first cladding portion passes through a drying channel between the two heating sheets to solidify the first conductive portion forming solvent.

11. The apparatus of claim 6, wherein the first feeder is a precision slot die, and the second feeder is a spray printed head.

12. The apparatus of claim 6, wherein a rotating direction of the first auxiliary roller is substantially the same as a rotating direction of the second auxiliary roller and is opposite to a rotating direction of the first pressing roller.

13. The apparatus of claim 12, wherein the first roller pressing device further comprises a first transmission roller between the first releasing reel and the first auxiliary roller.

14. The apparatus of claim 12, wherein the second roller pressing device further comprises a second transmission roller between the first roller pressing device and the second feeder.

15. The apparatus of claim 12, wherein the third roller pressing device further comprises a third transmission roller between the second releasing reel and the second pressing rollers.

16. The apparatus of claim 12, wherein the third roller pressing device further comprises a fourth transmission roller between the second pressing rollers and the fourth roller pressing device.

17. The apparatus of claim 16, further comprising a supporting roller between the fourth transmission roller and the fourth roller pressing device.
